(19) United States
(12) Patent Application Publication
(10) Pub. No.: US 2012/0263931 A1
(43) Pub. Date: Oct. 18, 2012

(54) LIGHT WEIGHT COMPOSITE STRUCTURAL SUPPORT MATERIAL HAVING NATURAL OIL AND POLYOL FOAM BONDED DIRECTLY BETWEEN SUBSTRATES

(75) Inventors: Stuart B. Smith, Loganville, GA (US); Richard Guy, Mission Viejo, CA (US); Mark R. Gordon, Dacula, GA (US); Mark D. White, McDonough, GA (US)

(73) Assignee: ATI INDUSTRIES, INC., Mission Viejo, CA (US)

(21) Appl. No.: 13/445,772

(22) Filed: Apr. 12, 2012

Related U.S. Application Data
(60) Provisional application No. 61/474,700, filed on Apr. 12, 2011.

(51) Int. Cl. B32B 27/04; B32B 27/18; B32B 27/12; B32B 7/12; B32B 7/02

(52) U.S. Cl. 428/214; 428/317.5; 428/215

(57) ABSTRACT

A composite substrate includes first and second substrate layers with a polyurethane foam layer there between. The foam layer preferably penetrates into the first and second substrate layers to form very strong bonds without the need for intervening adhesives. A component of the foam material formulation is natural oil. The resultant composite substrate thereby has excellent load-bearing properties. It can also be manufactured with lower cost capital equipment and a reduced impact on the environment relative to substrates using more conventional foam formulations and bonding processes.

### RELATED APPLICATIONS

This non-provisional patent application claims priority to U.S. Provisional Application Ser. No. 61/474,700, entitled “COMPOSITE BOARD WITH NATURAL OIL AND POLYOL BASED FOAM DIRECTLY BONDING TO PAPERBOARD”, by Richard Guy et al., filed on Apr. 12, 2011, and incorporated herein by reference under the benefit of U.S.C. 119(e).

### FIELD OF THE INVENTION

The present invention is generally directed toward composite structural materials formed from substrates and polyurethane foam. More particularly the present invention concerns a lightweight rigid composite substrate with excellent flexural modulus properties utilizing foam formed from natural oil, polyol and MDI bonded directly between substrates without the use of an added adhesive.

### BACKGROUND

Composite substrates used for structural purposes are widely available. Perhaps the oldest of these is plywood. Through the years more of these materials have become available including composites made of a combination of ground wood and adhesives. These materials have a wide range of uses including furniture, construction and for mounting certain art.

Issues with the aforementioned applications of composite substrates include weight, cost and environmental issues. Furniture and frames made from wood/adhesive composites are particularly heavy. There is a desire to achieve similar structural goals with lighter and less costly materials.

Composite boards formed from foam and paperboard have at times been used for mounting art. Structurally these boards are marginally acceptable for mounting some art but are generally not acceptable to be used for furniture. The polyols used have been synthesized from proproxalated petroleum-based hydrocarbons. The polyols are mixed with blowing agents, surfactants, catalysts, fire retardants and then reacted with methyl diphenyl isocyanate to produce polyurethane foam.

To produce a conventional board a lamination conveyor system is used that has heated steel belts that operate at slow conveyor speeds in order to assure proper curing of the composite board and bonding of the foam to the board. In many cases an adhesive is used to form the bond between the board and the foam. Disadvantages of prior art processes include high capital costs due to the massive and long heated machinery required to produce a given amount of composite board material. Moreover, petroleum-based polyols processes can have a deleterious impact on the environment. What is needed is a new set of materials and a process that incurs a lower capital cost and environmental impact while producing composite substrates of much higher load-bearing integrity.

### BRIEF DESCRIPTION OF THE DRAWINGS

The above and other aspects, features and advantages will become more apparent from the description in conjunction with the following drawings presented by way of example and not limitation, wherein identical reference indicia in separate views indicate the same elements and the same combinations of elements throughout the drawings, and wherein:

FIG. 1 depicts a cross section of a composite substrate according to one aspect of the present invention.

FIG. 2 depicts a flow chart representation of a first preferred embodiment of a manufacturing process for producing the composite substrate depicted in FIG. 1.

FIG. 3 depicts a conveyor system for a second manufacturing process for producing the composite substrate depicted in FIG. 1.

FIG. 4 depicts a flow chart representation of a second preferred embodiment of a manufacturing process for producing the composite substrate depicted in FIG. 1.

FIG. 5 depicts a cross section of a composite foam board supporting a canvas.

### DETAILED DESCRIPTION OF THE PREFERRED EMBODIMENTS

The present invention concerns a novel substrate having excellent flexural modulus properties while being produced in a very simple manufacturing process. The substrate includes at least one rigid material that is directly bonded to polyurethane foam that is made in part with natural oil. The foam bonds directly to the substrate without the need for an intervening adhesive. In one preferred embodiment the substrate includes a porous surface enabling the foam to penetrate the substrate during bonding. This process of eliminating the adhesive simplifies the manufacturing process of the substrate while providing superior strength properties. The use of a natural oil based foam material benefits the environment. In an exemplary embodiment the foam is polyurethane foam.

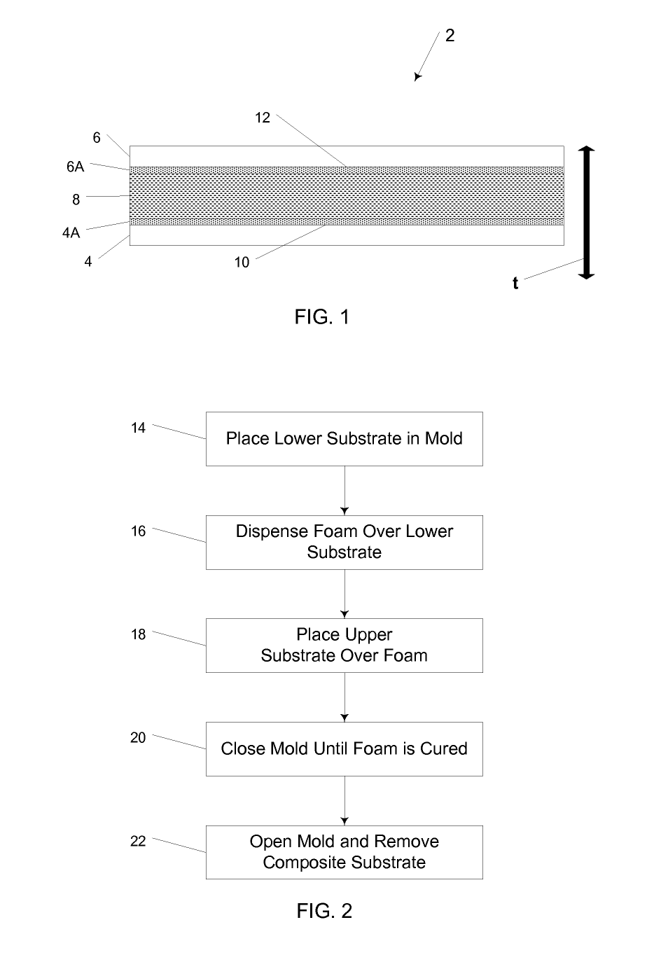

A composite substrate 2 of the present invention is depicted in cross-sectional form in FIG. 1. The composite substrate 2 includes a lower substrate 4, an upper substrate 6, with a foam layer 8 there between. Along a surface 10 that is a boundary between lower substrate 4 and foam layer 8 is a portion 4A of lower substrate 4 that contains material components of foam layer 8. This layer 4A is formed during the manufacture of the composite substrate prior to a complete cure of foam layer 8 such that material components of foam layer 8 wick and penetrate into the layer 4A of lower substrate 4. Depending upon the thickness of lower substrate 4, the layer 4A may extend into the majority of the overall thickness of lower substrate 4.

Also depicted is a similar layer portion 6A of an upper substrate 6 disposed along a boundary 12 between upper substrate 6 and foam layer 8 that contains material components of foam layer 8. Layer portion 6A is formed in a manner that is similar to that of layer 4A. Although layers 4A and 6A are depicted as uniform, they may vary in thickness due to variations in wicking and penetration of material components of foam layer 8 into the substrates 4 and 6.

Because of the zones 4A and 6A of the substrates 4 and 6, the foam layer bonds directly to the substrates 4 and 6 while the foam is curing and without the use of an added adhesive. This improves the composite strength of the composite substrate 2 and reduces manufacturing complexity.

A number of different materials may be used for substrates 4 and 6. Choice of these materials in combination with particular foam layer materials can provide composite substrates 2 with properties enabling applications that heretofore were not generally practical with conventional foam boards.

As a first substrate example, the substrates 4 and 6 are formed from MDF (medium density fiberboard) which is an engineered wood product formed from bonded together hardwood or softwood fibers. The MDF preferably varies in thickness (along dimension t) from 3 millimeters to 16 millimeters. For this example the foam may vary in thickness from 3 mm to 75 mm in thickness along the dimension t. The resultant composite substrate 2 may vary from 9 mm to over 100 mm and can function as a high performance building material. The resultant panels can be used to construct furniture and other load bearing articles or they can be used for construction applications.

As a second substrate example, substrates 4 and 6 can be formed from chipboard which is generally a paperboard made from reclaimed paper stock. For this second embodiment the paperboard can vary in thickness along dimension t from a value of at least 0.8 millimeters. In some embodiments the thickness is at least 0.9 millimeter or at least one millimeter. In other embodiments the thickness may be between 1 millimeter and 1.5 millimeters. In one embodiment the thickness is about 1.5 millimeters. In yet other embodiments the thickness may be greater than 1.5 millimeters. In one embodiment the foam layer is about 19 millimeters as measured along thickness direction t. In other embodiments the foam layer may vary between 3 millimeters to 25 millimeters as measured long the thickness direction t. In this second example the application may be a board for supporting artwork.

Other porous materials that can be used include wood and other wood-based substrates. Other materials may include non-porous substrates such as Formica, Plexiglas, and plastic. It may be advantageous to employ an adhesion promoter to create a molecular bond when using such materials.

As a third substrate example the two substrates 4 and 6 may be of different materials. For example, substrate 4 may be MDF or chipboard. Substrate 6 may be a canvas layer. This would provide art material suitable for immediate use and having its own backing. According to this example, the canvas may be coated with a latex material to prevent the foam from wicking through the canvas.

The foam material contains a natural oil made from a renewable resource such as a biological vegetable, plant, or tree. Examples of such natural oils include castor oil, soy bean oil, peanut oil, canola oil, and cashew oil to name a few. The natural oil may be mixed with one or more other components including sorbital, sucrose or an aliphatic polyol such as ethoxalated or propoxylated ethylenediamine that is soluble in the natural oil. In one embodiment the ratio of natural oil to polyol is about 1:3 by weight. Other components added to the foam may include water, a catalyst, a surfactant, and a fire retardant. In an exemplary embodiment the general formulation may be 75 PBW (parts by weight) propoxylated ethylenediamine polyol, 25 PBW natural oil, 3 PBW water, 0.4 PBW catalyst, 1.0 PBW surfactant, and 10 PBW fire retardant. MDI (methylene diphenyl diisocyanate) may be used as a co-reactant. Other formulations are possible depending upon desired foam density and reaction rates. Ranges of formulations vary from 60:40 PBW aliphatic polyol to natural oil, which creates a less rigid composite, to 90:10 PBW aliphatic polyol to natural oil, which creates a more rigid composite. This range of mix ratios may also apply to other materials such as sorbitol, sucrose, or mixtures of any of the aforementioned components.

As a first foam example the natural oil used is cashew oil. This oil has a molecular structure that allows it to form a very strong chemical bond with MDI. This results in a very rigid substrate and is particularly advantageous when used with MDF substrates, which are discussed above. An additional advantage of the cashew-based chemistry is that it chars rather than burns. This inherent fire resistance could be highly desirable in furniture and other interior applications. As a second example the oil used is a castor oil. This may be advantageous when used with a chipboard substrate.

The composite substrate of the present invention has substantial advantages over prior board materials. In an exemplary embodiment it is primarily formulated from recycled materials and/or renewable resources, so manufacture has a minimal impact on the environment. The composite substrate also has excellent material properties including compressive strength, shear strength, shear modulus, tensile strength, flexural strength, flexural modulus, closed cell content, and water absorption (into the foam-very low). Some exemplary properties are shown in the table below. In the table below a composite substrate was produced using 0.060″ chipboard and a castor oil based foam.

| | ASTM | | | | | | | Composite | |
|---|---|---|---|---|---|---|---|---|---|
| Physical | Method | Foam | | Foam | | Foam | | Using Foam | |
| Property | Used | Example 1 | | Example 2 | | Example 3 | | Example 2 | |
| Foam Density | D1622 | 2.5 | PCF | 4 | PCF | 6 | PCF | 4 | PCF |
| Compressive | D1621 | 37 | PSI | 82 | PSI | 140 | PSI | 82 | PSI |
| Strength | | | | | | | | | |
| Shear | C273 | 26 | PSI | 35 | PSI | 85 | PSI | 850 | PSI |
| Strength | | | | | | | | | |
| Shear | C273 | 253 | PSI | 312 | PSI | 788 | PSI | 2300 | PSI |
| Modulus | | | | | | | | | |
| Tensile | D1623 | 44 | PSI | 62 | PSI | 165 | PSI | 550 | PSI |
| Strength | | | | | | | | | |
| Flexural | C203 | 56 | PSI | 123 | PSI | 204 | PSI | 1120 | PSI |
| Strength | | | | | | | | | |
| Flexural | C203 | 963 | PSI | 2356 | PSI | 4785 | PSI | 325000 | PSI |
| Modulus | | | | | | | | | |
| Closed Cell | D2856 | >98% | | >98% | | >98% | | >98% | |
| Content | | | | | | | | | |
| Water | D2842 | <0.1% BY | | <0.1% BY | | <0.1% BY | | <0.1% BY | |
| Absorption 24 | | VOLUME | | VOLUME | | VOLUME | | VOLUME | |
| hr. immersion | | | | | | | | | |
| WVT | E96 | <1 | perm-inch | <1 | perm-inch | <1 | perm-inch | | |

Units indicated above are PSI (pounds per square inch) and PCF (pounds per cubic foot). The various strengths, water absorption properties, and water vapor transmission (WVT) are reported for a varying foam density from 2.5 to 6 pounds per cubic foot. Each of the foam examples are exemplary foams of the present invention and foams according to the present invention can be produced with parameters within the range of parameters listed above or outside of those ranges. For example, the foam density can range from 2.4 to 12 pounds per cubic foot, or even less than 2.4 pounds per square foot, or more than 12 pounds per square foot.

The resultant composite substrate has a shear modulus of at least about 1000 PSI or at least about 2000 PSI. The resultant composite substrate has a flexural modulus of at least 100,000 PSI or at least about 200,000 PSI or at least about 300,000 PSI.

A first exemplary process for manufacturing composite substrate 2 is depicted in FIG. 2 in flow chart form. The process depicted is performed in a mold cavity in order to constrain the dimensions of the resultant composite substrate 2.

Prior to step 14, substrates 4 and 6 are cut to size according to the dimensions of a mold to be used. According to step 14, lower substrate 4 is placed into the mold. According to step 16, the foam is dispensed over the lower substrate 4. According to step 18, upper substrate 6 is placed over the foam. According to step 20 the mold is closed over the composite board until the foam is cured.

While the foam is curing, it penetrates upper 6 and lower 4 substrates while it cures. The penetration and wicking process results in zones 4A and 6A (FIG. 1) in which foam material is penetrated into upper and lower substrates 4A and 6A. This is an important part of the process of FIG. 2 whereby a very strong composite material is formed.

While the mold is closed it also constrains the thickness of composite substrate 2. When curing is complete the mold is opened and composite substrate removed according to step 22.

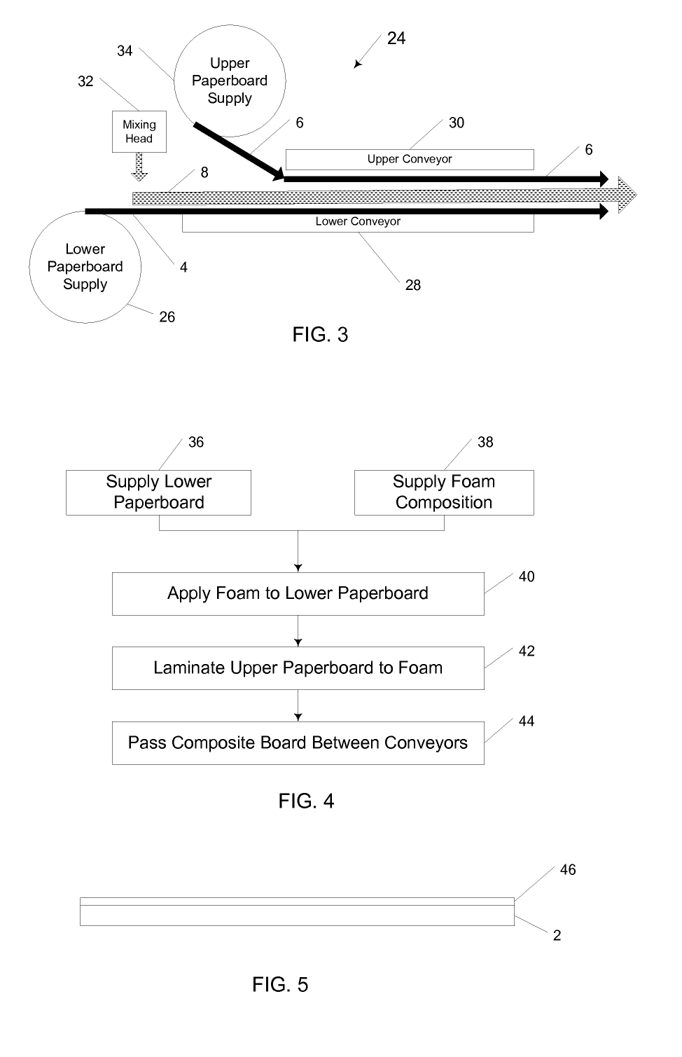

FIGS. 3 and 4 depicts a second exemplary process for manufacturing a composite substrate 2. A conveyor system 24 for manufacturing foam board 2 is depicted in FIG. 3. A lower substrate supply 26 provides lower substrate 4 to form the lower substrate layer 4. The lower substrate 4 is indicated as an arrow 4 since it moves from left to right in the figure between lower conveyor 28 and upper conveyor 30 during the process of forming a composite foam board 2.

A mixing head 32 dispenses the foam material 8 upon the lower substrate 4. Foam material 8 is also indicated by arrow 8 to indicate its transport direction between lower 28 and upper 30 conveyors. An upper substrate supply 34 provides upper substrate 6 whose motion is also indicated by arrows 6.

A method for manufacturing composite substrate 2 based on conveyor system 24 is depicted in FIG. 4. According to step 36, a lower substrate material 4 is supplied to conveyor system 24. In an exemplary embodiment the lower substrate material is a paperboard.

According to step 38, a polyurethane foam composition provided. In an exemplary embodiment the foam composition includes castor oil and propoxylated ethylenediamine polyol as the primary material components. Castor oil is soluble in this type of aliphatic polyol. Increasing the ratio of aliphatic polyol to oil increases the reaction rate of the material.

Water is added as a blowing agent to modulate the density of the foam whereby increased water lowers the density. With the natural oil and water as blowing agent, this process advantageously has no undesirable blowing byproducts that would harm the environment.

A catalyst is added to catalyze a curing reaction in the foam whereby more catalyst increases the cure rate. Also included are a surfactant and a fire retardant. MDI (methylene diphenyl diisocyanate) is used as a co-reactant.

An exemplary formulation would include the following: 75 PBW (parts by weight) propoxylated ethylenediamine polyol, 25 PBW Castor Oil, 3 PBW Water (H₂O), 0.4 PBW catalyst, 1.0 PBW surfactant, and 10 PBW fire retardant. MDI is also used as a co-reactant. Other formulations are possible, depending upon desired foam density and reaction rates.

According to step 40 the polyurethane foam mixture is sprayed or poured upon the lower substrate 4 at a temperature in a range of about 100-120 degrees Fahrenheit thereby forming foam layer 8. According to step 38 upper substrate layer 6 is supplied and laminated to the foam layer 8 between lower 28 and upper 30 conveyors. In an exemplary embodiment the upper substrate 6 material is a paperboard.

According to step 42 a composite of lower paperboard 4, foam layer 8, and upper paperboard 6 passes through conveyor system 24 as the foam penetrates the substrate layers 4 and 6 while curing. The lower 28 and upper 30 conveyors apply approximately 3-5 PSI (pounds per square inch) upon the composite material therebetween.

One big advantage of using this material and process is that the polyurethane foam quickly froths and cures without added heating elements on the conveyor belts. Therefore there is no need for very massive and long heated conveyors for curing the composite substrate 2. This lowers the capital cost of the overall machinery for fabricating the board 2. This is because the reaction of the components of foam 8 is exothermic in nature and generates enough heat to provide a full cure during transport of the composite materials between the conveyors. Depending upon the exact ratio of components in the foam material the conveyors can transport finished composite board material 2 out of conveyor system 24 at speeds of up to 50 feet per minute requiring a conveyor that may be only 50 feet long.

Board stock panels (composite substrates) 2 produced according to this process will have excellent material properties allowing their use in a wide variety of applications including wall and roof sheathing for houses, roofing for insulation, decorative panels, to name a few uses. A particularly advantageous use of panels 2 is to provide a very strong support for canvas 46 as in FIG. 4. Previously such supports for canvas have required wooden frames. It is the exceptionally flat and rigid characteristics of board 2 that enables it to provide a function previously provided by such a wooden frame.

Various alternative embodiments for the composite board 2 may be envisioned. In a first alternative embodiment a panel may incorporate a layer of canvas as a “skin” material. Referring back to FIG. 1, layers 4 and 6 each may be referred to as “skins” that bound the foam. In this first alternative embodiment, layer 4 is paperboard and layer 6 is canvas. Resultant composite boards 2 can therefore be directly used as artist boards, eliminating the need to attach canvas to the board.

In a second alternative embodiment, an outer surface of the canvas layer 6 has a layer of latex to prevent components of the foam material from wicking to the outer surface of the canvas. In a third alternative embodiment both layers 4 and 6 may be canvas.

The specific embodiments and applications thereof described above are for illustrative purposes only and do not preclude modifications and variations encompassed by the scope of the following claims.

What we claim is:

1. A composite substrate comprising:
a first substrate layer;
a second substrate layer; and
a foam layer bonding the first substrate layer to the second substrate layer, the foam layer penetrating the first substrate layer and the second substrate layer to form a rigid composite substrate thereby, a component of the foam layer is a natural oil.

2. The composite board of claim 1 wherein the first substrate layer and the second substrate layer each have a thickness of at least one millimeter.

3. The composite board of claim 1 wherein the first substrate layer and the second substrate layer each have a thickness of at least three millimeters.

4. The composite board of claim 1 wherein the first and second substrate layers are each formed from bonded wood fibers and each have a thickness in a range of 3 millimeters to 16 millimeters.

5. The composite substrate of claim 4 wherein the foam has a thickness range of 3 millimeters to 75 millimeters.

6. The composite substrate of claim 5 wherein the natural oil is a cashew oil.

7. The composite substrate of claim 1 wherein the first and second substrate layers are each formed from paperboard and each have a thickness in the range of 0.8 millimeter to 2.0 millimeters.

8. The composite substrate of claim 1 wherein the foam is formed from a mixture of a natural oil, a second component, and MDI (methylene diphenyl diisocyanate) wherein the second component is selected from the group consisting of sorbitol, sucrose, an aliphatic polyol, and mixtures thereof.

9. The composite substrate of claim 1 wherein the flexural modulus of the composite substrate is greater than 100,000 PSI.

10. The composite substrate of claim 1 wherein the shear modulus of the composite substrate is greater than 1000 PSI.

11. A canvas attached to a composite substrate according to claim 1.

12. The composite board of claim 1 wherein the foam is a polyurethane foam.

13. A composite board comprising:
a first substrate layer having a thickness range of 1 to 16 millimeters;
a second substrate layer having a thickness range of 1 to 16 millimeters;
an intervening foam layer bonding the first substrate to the second substrate, the foam layer having a thickness ranging from 3 to 75 millimeters, the intervening foam layer being formulated from a mixture including natural oil and a second component wherein the second component is selected from the group consisting of sorbitol, sucrose, an aliphatic polyol, and mixtures thereof.

14. The composite board of claim 13 wherein the aliphatic polyol is selected from the group consisting of ethoxalated polyol, propoxylated ethylenediamine polyol, and mixtures thereof.

15. The composite board of claim 13 wherein the first and second substrate layers are each formed from medium density fiberboard and each have a thickness in a range of 3 millimeters to 16 millimeters.

16. The composite board of claim 13 wherein the foam has a density within the range of 2.4 to 12 PCF (pounds per cubic foot).

17. The composite board of claim 13 wherein the foam is a polyurethane foam.

18. A composite substrate comprising:
a first substrate layer having a thickness range of 1 to 16 millimeters;
a second substrate layer having a thickness range of 1 to 16 millimeters;
a foam layer bonding the first substrate layer to the second substrate layer, the foam penetrating the first substrate layer and the second substrate layer to form a strong composite substrate without adhesives to bond the first and second substrate layers to the foam such that a layer of each of the first and second substrates that is adjacent to the foam contains the foam, the foam layer having a thickness in the range of 3 to 75 millimeters, the foam layer having a density 2.4 to 12 pounds per cubic foot, the foam having a formulation including a natural oil and a second component selected from a group consisting of sorbitol, sucrose, an aliphatic polyol, and mixtures thereof.

19. The composite board of claim 18 wherein the aliphatic polyol is selected from the group consisting of ethoxalated polyol, propoxylated ethylenediamine polyol, and mixtures thereof.

20. The composite board of claim 18 wherein the first and second substrate layers are each formed from medium density fiberboard and each have a thickness in a range of 3 millimeters to 16 millimeters.

21. The composite board of claim 18 wherein the natural oil is selected from the group consisting of cashew oil, castor oil, soy oil, and palm oil.

22. The composite board of claim 18 wherein the foam also contains MDI, water, a catalyst, and a surfactant.

23. The composite board of claim 18 wherein the foam is a polyurethane foam.
